(19) United States
(12) Patent Application Publication
(10) Pub. No.: US 2014/0167494 A1
(43) Pub. Date: Jun. 19, 2014

(54) VEHICLE BRAKING SYSTEM AND METHOD FOR CONTROLLING THE SAME

(71) Applicant: Hyundai Motor Company, Seoul (KR)

(72) Inventor: Gab Bae Jeon, Hwaseong (KR)

(73) Assignee: Hyundai Motor Company, Seoul (KR)

(21) Appl. No.: 14/097,726

(22) Filed: Dec. 5, 2013

(30) Foreign Application Priority Data
Dec. 13, 2012 (KR) 10-2012-0145728

(51) Int. Cl. B60T 13/66; B60T 7/04

(52) U.S. Cl. CPC B60T 13/66; B60T 7/042
USPC 303/10; 303/20; 701/70

(57) ABSTRACT

A vehicle braking system is provided that includes a brake pedal; a pedal simulator that generates reaction force corresponding to the brake pedal force and a pedal position sensor that detects a brake pedal operating state. A booster boosts brake pedal force and a master cylinder generates hydraulic pressure by activating the booster. A hydraulic controller is activated by the master cylinder and activates a wheel cylinder. A hydraulic power unit includes a cut valve controlling brake fluid supply between a reservoir and the pedal simulator, apply valves selectively supplying brake operating fluid to the booster and release valves selectively releasing the brake operating fluid from the booster. A switch unit selects reaction force modes and a controller operates the hydraulic power unit based on an output signal from the pedal position sensor, and adjusts the cut valve timing based on reaction force mode transmitted from the switch unit.

### CROSS-REFERENCE TO RELATED APPLICATION

This application claims priority to and the benefit of Korean Patent Application No. 10-2012-0145728 filed in the Korean Intellectual Property Office on Dec. 13, 2012, the entire contents of which are incorporated herein by reference.

### BACKGROUND

(a) Field of the Invention

The present invention relates to a vehicle braking system and a method for controlling the vehicle braking system, and more particularly, to a vehicle braking system that selects reaction force and braking force as required and a method for controlling the vehicle braking system.

(b) Description of the Related Art

A general brake system has a relationship of a brake pedal force-pedal stroke-hydraulic braking force. This pedal force-stroke-braking force relationship is determined by a mechanical hydraulic system. Although the braking force-stroke-pedal force relationship may be changed by adjusting the components of the brake system, the relationship of pedal force-stroke-braking force is not changed after tuning. In other words, braking force is determined by the area of a wheel cylinder, the friction coefficient of friction materials, the effective radius of a disc, hydraulic pressure, etc.

In addition, pedal force is determined by the cross-sectional area of a master cylinder, brake pedal ratio, the boosting force of a booster, hydraulic pressure, etc. Stroke is determined by the cross-sectional area of the master cylinder, brake pedal ratio, the wheel cylinder, the amount of brake operating fluid required for all hydraulic lines, and on the like. These three properties are determined by mechanical factors, whereby only one relationship of pedal force-stroke-braking force is established. Accordingly, in a general brake system, pedal reaction force, which is determined by discs, calipers, pipes, a master cylinder, a booster, has only one pattern.

Although pedal simulators are applied to hybrid vehicles, electric vehicles (EV), and premium vehicles, the developed conventional simulators only have one braking force-pedal force-stroke relationship. Pedal reaction force generated by a general brake system only gas one pattern, whereas vehicle drivers desire various patterns of pedal reaction force. Some drivers may prefer low pedal reaction force and moderate braking force, while some drivers may prefer high pedal reaction force and high braking force. However, general brake systems cannot provide various patterns of pedal reaction forces and braking forces as required by drivers.

The above information disclosed in this section is only for enhancement of understanding of the background of the invention and therefore it may contain information that does not form the prior art that is already known in this country to a person of ordinary skill in the art.

### SUMMARY

The present invention provides a vehicle braking system that selects reaction force and braking force as required. An exemplary embodiment of the present invention provides a vehicle braking system that may include: a brake pedal; a pedal simulator that generates a reaction force corresponding to the force of the brake pedal; a pedal position sensor that detects an operating state of the brake pedal and outputs a corresponding signal; a booster that boosts the force of the brake pedal; a master cylinder that generates a hydraulic pressure by activating the booster; a hydraulic controller that is activated by the master cylinder; a wheel cylinder that is activated by the hydraulic controller; a reservoir that stores brake operating fluid; a hydraulic power unit including a cut valve that controls the supply of brake fluid between the reservoir and the pedal simulator, apply valves that selectively supply brake operating fluid to the booster and release valves that selectively release the brake operating fluid from the booster; a switch unit that selects a plurality of reaction force modes; and a controller that operates the hydraulic power unit in response to receiving an output signal from the pedal position sensor, and adjusts the operating timing of the cut valve based on a reaction force mode transmitted from the switch unit to operate the cut valve.

The reaction force modes may include: a predetermined basic mode; a delay mode in which the operation timing of the cut valve is delayed for a predetermined time period compared to the basic mode; and a fast mode in which the operation timing of the cut valve is increased compared to with the basic mode.

The apply valves may include a plurality of solenoid valves that are closed. The release valves may include a plurality of solenoid valves that are open. The switch unit may select a plurality of braking modes, and the controller may operate the apply valves and the release valves based on a braking mode transmitted from the switch unit using a control signal that corresponds to a predetermined map.

The hydraulic power unit may further include: a pump that pumps the brake operating fluid from the reservoir; a motor that drives the pump; and an accumulator that temporarily stores the brake operating fluid discharged from the pump and supplies the brake operating fluid to the apply valves when the apply valves are open.

The vehicle braking system may include: a first hydraulic sensor disposed on a hydraulic line connecting the cut valve and the pedal simulator, and measuring the hydraulic pressure of the pedal simulator; a second hydraulic sensor disposed on a hydraulic line connecting the pump and the accumulator; and measuring the hydraulic pressure of the accumulator; and a third hydraulic sensor disposed on a hydraulic line connecting the booster and the apply valves and the release valves, and measuring the hydraulic pressure of the booster.

Another exemplary embodiment of the present invention provides a method for controlling the vehicle braking system, the method may include: detecting a reaction force mode selection signal; in response to no reaction force mode selection signal being detected, controlling the operation timing of the cut valve in response to a stored reaction force mode signal; and in response to detecting a reaction force mode selection signal, controlling the operation timing of the cut valve in response to a selected reaction force mode signal, and storing the reaction force mode signal.

The reaction force modes may include: a predetermined basic mode; a delay mode in which the operation timing of the cut valve is delayed for a predetermined time period compared to the basic mode; and a fast mode in which the operation timing of the cut valve is increased compared to the basic mode.

Yet another exemplary embodiment of the present invention provides a method for controlling the vehicle braking system, the method may include: identifying a reaction force mode selection signal; identifying a braking mode selection signal; in response to no reaction force mode selection signal and no braking mode selection signal being detected, controlling the operation timing of the cut valve in response to a stored reaction force mode signal and controlling the operations of the apply valves and the release valves in response to a stored braking mode signal; in response to no reaction mode selection signal being detected and a braking mode selection signal being detected, controlling the operation timing of the cut valve in response to a stored reaction force mode selection signal, controlling the operations of the apply valves and the release valves in response to a selected braking mode signal, and storing the selected braking mode signal; in response to a reaction force mode selection signal and a braking mode selection signal being detected, controlling the operation timing of the cut valve in response to a selected reaction force mode signal, controlling the operations of the apply valves and the release valves in response to a selected braking mode signal, and storing the selected reaction force mode signal and the selected braking mode signal; and in response a reaction force mode selection signal being detected and no braking mode selection signal being detected, controlling the operation timing of the cut valve in response to a selected reaction force mode signal, controlling the operations of the apply valves and the release valves in response to a stored braking mode signal, and storing the selected reaction force mode signal.

A vehicle braking system and a method for controlling the same accordingly to exemplary embodiments of the present invention allow the driver to select the pedal reaction force versus pedal stroke according to their preference, without making major changes to the configuration of a general brake system. Moreover, it may be possible to select a braking force versus pedal stroke map according to the driver's preference.

### BRIEF DESCRIPTION OF THE DRAWINGS

FIG. 1 is an exemplary view showing a vehicle braking system according to an exemplary embodiment of the present invention;

FIG. 2 is an exemplary block diagram of the vehicle braking system according to the exemplary embodiment of the present invention;

FIG. 3 is an exemplary flowchart illustrating a method for operating a vehicle braking system according to an exemplary embodiment of the present invention;

FIG. 4 is an exemplary graph showing the relationship between the pedal reaction force and pedal stroke of the vehicle braking system according to the exemplary embodiment of the present invention; and

FIG. 5 is an exemplary graph showing the relationship between the braking force and pedal stroke of the vehicle braking system according to the exemplary embodiment of the present invention.

Description of symbols

| 10: brake pedal | 15: hydraulic power unit |
|---|---|
| 20: pedal position sensor | 30: pedal simulator |
| 32: reaction force generator | 40: booster |
| 50: master cylinder | 60: reservoir |
| 70: hydraulic controller 80: wheel cylinder | |
| 90: cut valve | 100: motor |
| 102: pump | 110: first release valve |
| 120: second release valve | 130: first apply valve |
| 140: second apply valve | 150: accumulator |
| 160: first hydraulic pressure sensor | |
| 162: second hydraulic pressure sensor | |
| 164: third hydraulic pressure sensor | |
| 200: controller | 210: switch unit |

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, fuel cell vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following detailed description, only certain exemplary embodiments of the present invention have been shown and described, simply by way of illustration. As those skilled in the art would realize, the described embodiments may be modified in various different ways, all without departing from the spirit or scope of the present invention. Throughout the specification, the same reference numerals represent the same components. In the drawings, the thickness of layers, films, panels, regions, etc., are exaggerated for clarity.

It will also be understood that when an element such as a layer, film, area, or plate is referred to as being “on” another element, it can be directly on the other element, or one or more intervening element may also be present. In contrast, when an element is referred to as being “directly on” another element, there are no intervening elements present. Throughout the specification, unless explicitly described to the contrary, the word “comprise” and variations such as “comprises” or “comprising,” will be understood to imply the inclusion of stated elements but not the exclusion of any other elements.

An exemplary embodiment of the present invention will hereinafter be described in detail with reference to the accompanying drawings.

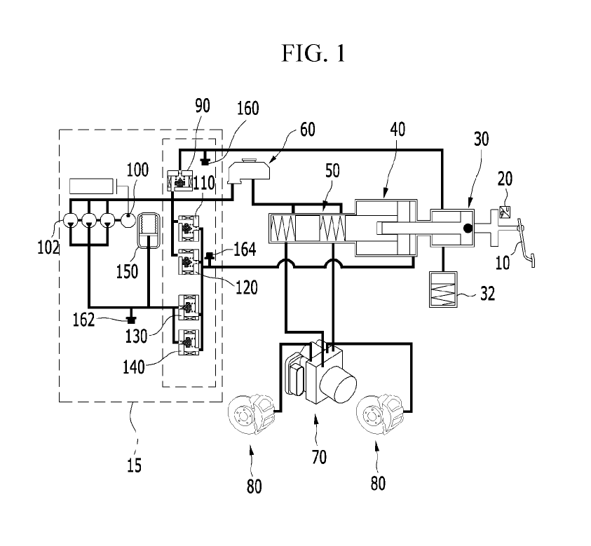

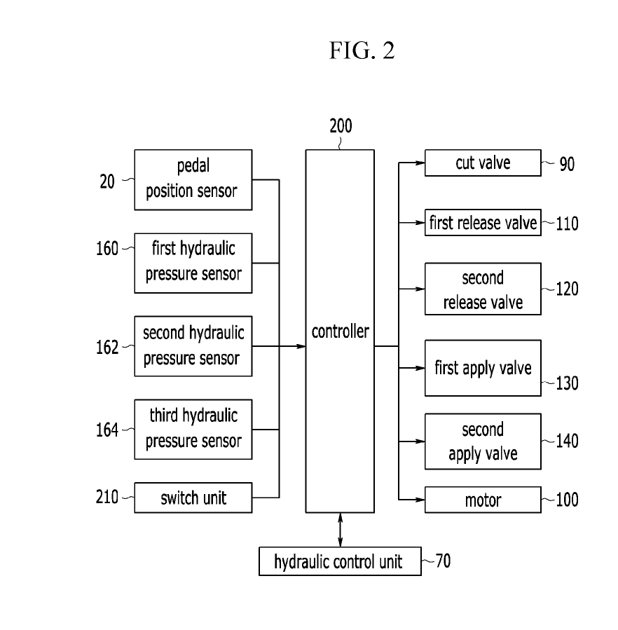

FIG. 1 is an exemplary view showing a vehicle braking system according to an exemplary embodiment of the present invention. FIG. 2 is an exemplary block diagram of the vehicle braking system according to the exemplary embodiment of the present invention.

Referring to FIGS. 1 and 2, a vehicle braking system may include a brake pedal 10, a pedal simulator 30 configured to generate a reaction force that corresponds to the force of the brake pedal 10, a pedal position sensor 20 configured to detect an operating state of the brake pedal 10 and output a corresponding signal, a booster 40 configured to boost the force of the brake pedal 10, a master cylinder 50 configured to generate a hydraulic pressure by activating the booster 50, a hydraulic controller 70 configured to be activated by the master cylinder 50, a wheel cylinder 80 configured to be activated by the hydraulic controller 70, a reservoir 60 configured to store brake operating fluid, a hydraulic power unit 15 that includes a cut valve 90 configured to control the supply of brake fluid between the reservoir 60 and the pedal simulator 30, apply valves 130 and 140 configured to selectively supply brake operating fluid to the booster 40 and release valves 110 and 120 configured to selectively release the brake operating fluid from the booster 40, a switch unit 210 configured to select a plurality of reaction force modes, and a controller 200 configured to operate the hydraulic power unit 15 in response to receiving an output signal from the pedal position sensor 20, and adjust the operating timing of the cut valve 90 based on a reaction force mode transmitted from the switch unit 210 to operate the cut valve 90.

The apply valves 130 and 140 may include a plurality of normally closed (NC) solenoid valves. The release valves 110 and 120 may include a plurality of normally open (NO) solenoid valves. The hydraulic power unit 15 may further include a pump 102 configured to pump the brake operating fluid from the reservoir 60, a motor 100 configured to drive the pump 102, and an accumulator 150 configured to temporarily stores the brake operating fluid discharged from the pump 102 and supply the braking operating fluid to the apply valves 130 and 140 when the apply valves 130 and 140 are open.

The vehicle braking system may include a first hydraulic sensor 160 disposed on a hydraulic line connecting the cut valve 90 and the pedal simulator 30, and measuring the hydraulic pressure of the pedal simulator 30, a second hydraulic sensor 162 disposed on a hydraulic line connecting the pump 102 and the accumulator 150, and measuring the hydraulic pressure of the accumulator 150; and a third hydraulic sensor 164 disposed on a hydraulic line connecting the booster 40 and the apply valves 130 and 140 and the release valves 110 and 120, and measuring the hydraulic pressure of the booster 40.

The reaction force modes may include a predetermined basic mode, a delay mode in which the operation timing of the cut valve is delayed for a predetermined time period compared to the basic mode, and a fast mode in which the operation timing of the cut valve is increased for a predetermined time period compared to the basic mode.

The switch unit 210 may be configured to select a plurality of braking modes, and the controller 200 may be configured to operate the apply valves 130 and 140 and the release valves 110 and 120 based on a braking mode transmitted from the switch unit 210 using a control signal that corresponds to a predetermined map. In addition, the controller 200 may be configured to determine the pressure of the pedal simulator 30 based on a signal from the first hydraulic sensor 160 and a target braking amount desired by the driver based on the stroke of the brake pedal 10 transmitted from the pedal position sensor 20, and operate the driving of the hydraulic power unit 15 and the hydraulic controller 70 to reach the target braking amount.

When the driver engages the brake pedal 10, the controller 200 may be configured to close the first and second release valves 110 and 120 and open the first and second apply valves 130 and 140, in response to receiving a signal from the pedal position sensor 20, to increase the pressure of the wheel cylinder 80. When the driver releases (e.g., disengages) the brake pedal 10, the controller 200 may be configured to open the first and second release valves 110 and 120 and close the first and second apply valves 130 and 140, in response to receiving a signal from the pedal position sensor 20, to reduce the pressure of the wheel cylinder 80.

When the brake operating fluid in the booster 40 is supplied to the master cylinder 50, the controller 200 may be configured to operate the driving of the hydraulic controller 70 to increase or reduce the pressure of the brake operating fluid and supply the brake operating fluid to the wheel cylinder 80. In addition, the controller 200 may be configured to monitor the pressures of the accumulator 150 and the booster 40 using a second hydraulic sensor 162 and a third hydraulic sensor 164. During a braking operation, the controller 200 may be configured to operate the driving of the cut valve 90 to close the cut valve 90, and operate the driving of the first and second apply valves 130 and 140 to open the apply valves 130 and 140, thereby allowing the high-pressure brake operating fluid stored in the accumulator 150 to be supplied to the booster 40.

When the driver releases the pressure on the pedal 10, the controller 200 may be configured to operate the driving of the cut valve 90 to close the cut valve 90, and operate the driving of the first and second release valves 110 and 120 to open the valves 110 and 120, thereby allowing the brake operating fluid in the booster 40 to be released to the reservoir 60. In addition, the controller 200 allows the cut valve 90 to be opened while driving, and operates the driving of the motor 100 to supply the brake operating fluid in the reservoir 60 to the accumulator 150.

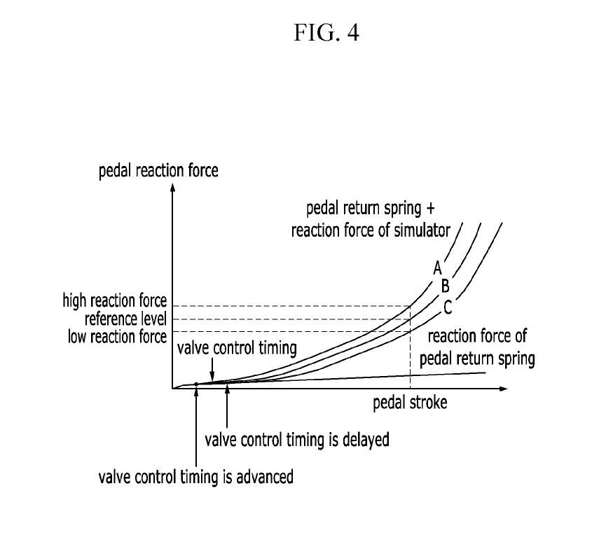

FIG. 4 is an exemplary graph showing the relationship between the pedal reaction force and pedal stroke of the vehicle braking system according to the exemplary embodiment of the present invention. FIG. 4 depicts lines that indicate the reaction force of a pedal return spring and the sum of the reaction force of the pedal return spring and the reaction of the pedal simulator. The reference B denotes the line indicating the basic mode, which is predetermined, and the references A and C denote the lines indicating the fast mode and the delay mode, respectively.

In the vehicle braking system according to the exemplary embodiment of the present invention, the controller 200 may be configured to operate the cut valve 90 based on a reaction force mode selected by the switch unit 210. In other words, the operation timing of the cut valve 90 responsive to a detection signal from the pedal position sensor 20 may be adjusted to be advanced (A) or delayed (C) compared to the basic mode (B). In the reaction force mode selected by the driver, difference reaction forces may be generated with respect to the same pedal stroke shown in FIG. 4. Accordingly, the driver may select a reaction force mode based on a driving style.

For better comprehension and ease of description, the exemplary embodiment of the present invention has been described with respect to an example in which the reaction force mode includes the basic mode, the delay mode, and the fast mode; however, the present invention is not limited thereto, and the operation timing of the cut valve 90 may be varied to select various modes.

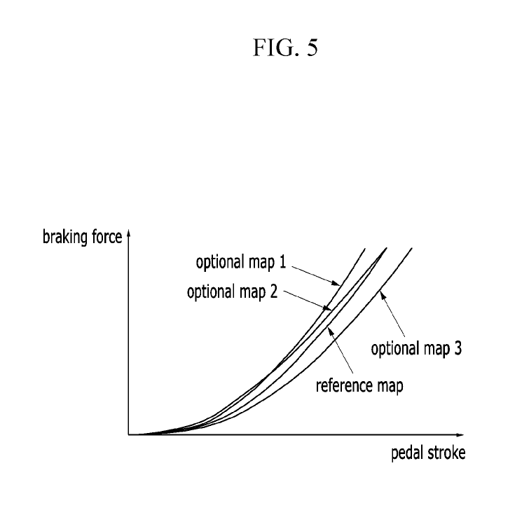

FIG. 5 is an exemplary graph showing the relationship between the braking force and pedal stroke of the vehicle braking system according to the exemplary embodiment of the present invention.

The braking force versus pedal stroke may be determined by activating the booster 40, and the activation of the booster 40 may be determined by operating the apply valves 130 and 140 and the release valves 110 and 120. The controller 200 of the vehicle braking system may be configured to store a plurality of maps, as well as a predetermined reference map, as shown in FIG. 5, and the switch unit 210 may be configured to select a braking mode desired by the driver from among the plurality of maps.

In other words, a reference map may be set by considering braking forces desired by many drivers, and “optional map 1” for generating braking force at substantially small strokes, “optional map 2” for producing substantially large changes in braking force according to changes in stroke, and “optional map 3” for producing substantially small changes in braking force according to changes in stroke may be created in advance and stored in the controller 200. In addition, when the driver operates the switch unit 210, the controller 200 may be configured to operate the apply valves 130 and 140 and the release valves 110 and 120 based on a map selected by the switch unit 210. Accordingly, the vehicle braking system according to the exemplary embodiment of the present invention may implement various braking modes based on the driver's preference.

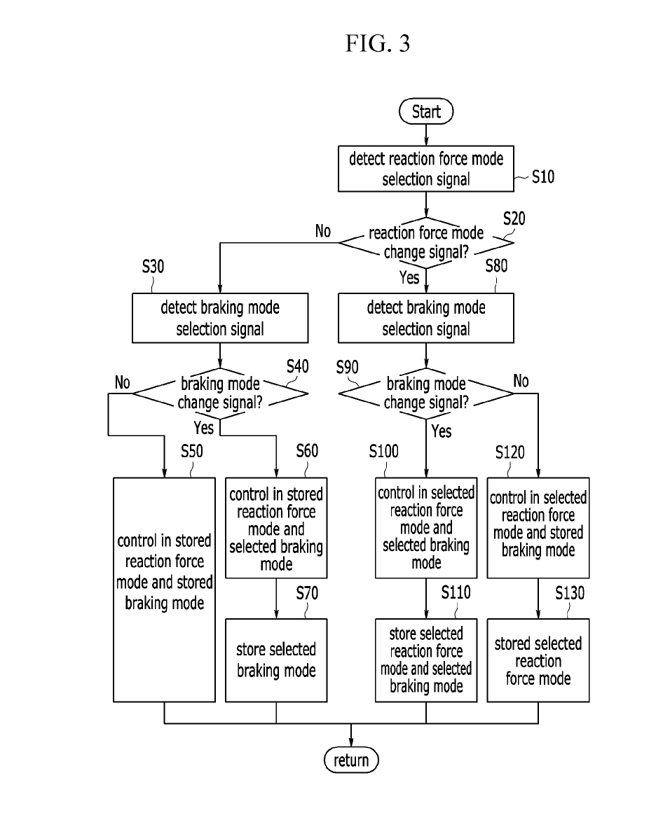

FIG. 3 is an exemplary flowchart illustrating a method for operating a vehicle braking system in accordance with an exemplary embodiment of the present invention. Description will be made of the case where the switch unit 210 of the vehicle braking system may be configured to select a reaction force mode, and the controller 200 may be configured to adjust the operation timing of the cut valve 90 in the selected reaction force mode.

The method for operating the vehicle braking system according to the exemplary embodiment of the present invention may include detecting, by a controller, a reaction force mode selection signal (S10); in response to no reaction force mode selection signal being detected, operating, by the controller, the operation timing of the cut valve in response to a stored reaction force mode signal (S50); in response to detecting a reaction force mode selection signal, operating, by the controller, the operation timing of the cut valve in response to a selected reaction force mode signal (S100 and S120); and storing, by the controller, the reaction force mode signal (S110 and S130).

Hereinbelow, description will be made of the case where the switch unit 210 of the vehicle braking system may be configured to select a reaction force mode and a braking mode, and the controller 200 may be configured to adjust the operation timing of the cut valve 90 in the selected reaction force mode and operate the apply valves 130 and 140 and the release valves 110 and 120 in the selected braking mode.

The method for operating the vehicle braking system according to the exemplary embodiment of the present invention may include: detecting, by a controller, a reaction force mode selection signal (S10); identifying, by the controller, the reaction force mode selection signal (S20); detecting, by the controller, a braking mode selection signal (S30 and S80); identifying, by the controller, the braking mode selection signal (S40 and S90); in response to no reaction force mode selection signal and no braking mode selection signal being detected, operating, by the controller, the timing of the cut valve 90 in response to a stored reaction force mode signal and operating the apply valves 130 and 140 and the release valves 110 and 120 in response to a stored braking mode signal (S50); in response to no reaction mode selection signal being detected and detecting a braking mode selection signal, operating, by the controller, the timing of the cut valve 90 in response to a stored reaction force mode selection signal, and operating the apply valves 130 and 140 and the release valves 110 and 120 in response to a selected braking mode signal (S60); storing, by the controller, the selected braking mode signal (S70); in response to detecting a reaction force mode selection signal and a braking mode selection signal, operating, by the controller, the timing of the cut valve 90 in response to a selected reaction force mode signal, and operating the apply valves 130 and 140 and the release valves 110 and 120 in response to a selected braking mode signal (S100); storing, by the controller, the selected reaction force mode signal and the selected braking mode signal (S110); in response to detecting a reaction force mode selection signal and no braking mode selection signal being detected, operating the timing of the cut valve 90 in response to a selected reaction force mode signal, and operating the apply valves 130 and 140 and the release valves 110 and 120 in response to a stored braking mode signal (S120); and storing, by the controller, the selected reaction force mode signal (S130).

As explained above, a vehicle braking system and a method for operating the vehicle braking system according to exemplary embodiments of the present invention may allow the driver to select the pedal reaction force versus pedal stroke according to their preference, without making major changes to the configuration of a general brake system. In addition, the vehicle braking system and the method for operating the vehicle braking system may allow the driver to select the braking force versus pedal stroke according to their preference.

While this invention has been described in connection with what is presently considered to be exemplary embodiments, it is to be understood that the invention is not limited to the disclosed embodiments. On the contrary, it is intended to cover various modifications and equivalent arrangements included within the spirit and scope of the accompanying claims.

What is claimed is:

1. A vehicle braking system comprising:
a brake pedal;
a pedal simulator configured to generate a reaction force that corresponds to the force of the brake pedal;
a pedal position sensor configured to detect an operating state of the brake pedal and outputs a corresponding signal;
a booster configured to boost the force of the brake pedal;
a master cylinder configured to generate a hydraulic pressure by activating the booster;
a hydraulic controller configured to be activated by the master cylinder;
a wheel cylinder configured to be activated by the hydraulic controller;
a reservoir configured to store brake operating fluid;
a hydraulic power unit including a cut valve configured to control the supply of brake fluid between the reservoir and the pedal simulator, apply valves configured to selectively supply brake operating fluid to the booster and release valves configured to selectively release the brake operating fluid from the booster;
a switch unit configured to select a plurality of reaction force modes; and
a controller configured to operate the hydraulic power unit upon in response to receiving an output signal from the pedal position sensor, and adjust the operating timing of the cut valve based on a reaction force mode transmitted from the switch unit to operate the cut valve.

2. The vehicle braking system of claim 1, wherein the reaction force modes includes:
a predetermined basic mode;
a delay mode in which the operation timing of the cut valve is delayed for a predetermined time period compared to the basic mode; and
a fast mode in which the operation timing of the cut valve is increased for a predetermined time period compared to the basic mode.

3. The vehicle braking system of claim 1, wherein the apply valves include a plurality of normally closed solenoid valves.

4. The vehicle braking system of claim 1, wherein the release valves include a plurality of normally open solenoid valves.

5. The vehicle braking system of claim 1, wherein the switch unit is configured to select a plurality of braking modes and the controller is configured to operate the apply valves and the release valves based on a braking mode transmitted from the switch unit using a control signal that corresponds to a predetermined map.

6. The vehicle braking system of claim 1, wherein the hydraulic power unit further includes:
a pump configured to pump the brake operating fluid from the reservoir;
a motor configured to drive the pump; and
an accumulator configured to temporarily store the brake operating fluid discharged from the pump and supply the brake operating fluid to the apply valves when the apply valves are open.

7. The vehicle braking system of claim 6, wherein the vehicle braking system includes:
a first hydraulic sensor disposed on a hydraulic line connecting the cut valve and the pedal simulator, and measuring the hydraulic pressure of the pedal simulator;
a second hydraulic sensor disposed on a hydraulic line connecting the pump and the accumulator; and measuring the hydraulic pressure of the accumulator; and
a third hydraulic sensor disposed on a hydraulic line connecting the booster and the apply valves and the release valves, and measuring the hydraulic pressure of the booster.

8. A method for operating the vehicle braking system of claim 1, the method comprising:
detecting, by a controller, a reaction force mode selection signal;
in response to no reaction force mode selection signal being detected, operating, by the controller, the timing of the cut valve in response to a stored reaction force mode signal; and
in response to detecting a reaction force mode selection signal, operating, by the controller, the timing of the cut valve in response to a selected reaction force mode signal, and storing, by the controller, the reaction force mode signal.

9. The method of claim 8, wherein the reaction force modes include:
a predetermined basic mode;
a delay mode in which the operation timing of the cut valve is delayed for a predetermined time period compared to the basic mode; and
a fast mode in which the operation timing of the cut valve is increased for a predetermined time period compared to the basic mode.

10. A method for operating the vehicle braking system of claim 5, the method including:
identifying, by a controller, a reaction force mode selection signal;
identifying, by the controller, a braking mode selection signal;
in response to no reaction force mode selection signal and no braking mode selection signal being detected, operating, by the controller, the timing of the cut valve in response to a stored reaction force mode signal and operating the apply valves and the release valves in response to a stored braking mode signal;
in response no reaction mode selection signal being detected and detecting a braking mode selection signal, operating, by the controller, the timing of the cut valve in response to a stored reaction force mode selection signal, operating, by the controller, the apply valves and the release valves in response to a selected braking mode signal, and storing, by the controller, the selected braking mode signal.
in response to detecting a reaction force mode selection signal and a braking mode selection signal, operating, by the controller, the timing of the cut valve in response to a selected reaction force mode signal, operating, by the controller, the apply valves and the release valves in response to a selected braking mode signal, and storing, by the controller, the selected reaction force mode signal and the selected braking mode signal;
in response to detecting a reaction force mode selection signal and no braking mode selection signal being detected, operating, by the controller, the timing of the cut valve in response to a selected reaction force mode signal, operating, by the controller, the apply valves and the release valves in response to a stored braking mode signal, and storing, by the controller, the selected reaction force mode signal.
